(19) United States
(12) Patent Application Publication
(10) Pub. No.: US 2009/0077639 A1
(43) Pub. Date: Mar. 19, 2009

(54) SYSTEM AND METHOD OF PROCESSING AN AUTHORING ASSIGNMENT

(76) Inventors: James Williams, Coventry, CT (US); Juergen Lumera, Fahrenzhausen (DE); Karen Lease, Versailles (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/958,034

(22) Filed: Dec. 17, 2007

Related U.S. Application Data
(60) Provisional application No. 60/972,062, filed on Sep. 13, 2007.

(51) Int. Cl. G06F 7/04

(52) U.S. Cl. 726/5

(57) ABSTRACT

A system and method of processing an authoring assignment enable an authoring assignment to be requested, forwarded, created, modified, accepted, rejected, and published electronically. A request that an authoring assignment be completed may be created and communicated electronically using an authoring assignment processing system. The request may be received by one or more users that may process the assignment. A completed assignment may be forwarded for approval to the user that requested the assignment. The requestor may approve or reject the assignment. A notification may be transmitted, for example, via electronic mail, text message, phone call, facsimile, etc. to the user that created the assignment notifying the user that the assignment has been approved or rejected. The assignment may be forwarded to another user, published, or have another function performed thereon. The system and method may maintain a history of actions performed on the assignment and data relating to each of the actions. Notes and other documents may be attached to the authoring assignment. The request and assignment may be stored as proxy documents. The proxy documents may be converted to a final document upon acceptance of the assignment. The proxy documents contain metadata of the final document that enable the proxy document to act as the final document until the final document is created.

### CROSS-REFERENCE TO RELATED APPLICATIONS

This application claims priority to U.S. Provisional Patent Application Ser. No. 60/972,062, filed Sep. 13, 2007, titled “System and Method of Processing an Authoring Assignment,” and is related to U.S. patent application titled “System of Managing User Roles in an Automated Workflow Process,” attorney docket no. 87400.1720, filed herewith, U.S. patent application titled “System of Modifying Illustrations Using Scaleable Vector Graphics,” attorney docket no. 87400.1721, filed herewith, and U.S. patent application titled “System of Managing Workflow of an Authoring Assignment,” attorney docket no. 87400.1722, filed herewith, the disclosures of each which are hereby incorporated by reference in their entirety.

### FIELD OF THE INVENTION

The invention relates generally to a system and method of processing an authoring assignment. More particularly, the invention relates to a system and method that automate an authoring assignment process.

### BACKGROUND OF THE INVENTION

Processing authoring assignments, such as, for example, graphic requests, typically requires multiple drafts and conveying of the authoring assignment back and forth between at least two persons. For example, for a graphic request, a content author creates a request for an authoring assignment. The request is forwarded to a graphic artist to prepare the graphic. The request is typically created manually using pen and paper and forwarded to the graphic artist using, for example, an inter-office envelope, regular mail, facsimile or other manner. Depending on the methods available for forwarding the authoring assignment, this may cause delays in having an authoring assignment completed. The graphic artist prepares the request and forwards a completed assignment to the content author. The completed assignment may be returned to the content author in the same manner that the request was received or other manner.

The content author receives the completed assignment and reviews the assignment to determine whether the assignment has been properly completed. If the assignment has been completed properly, the content author may accept the assignment, may forward the assignment to another person (using the manners described above), such as, for example, for an acceptance determination, publish the assignment or perform another function with the assignment. Typically, unless the content author advises the graphic artist that the assignment has been properly completed, the graphic artist is not aware that the assignment has been accepted. The graphic artist then remains unsure regarding whether his role in processing that assignment has been completed. This may cause the graphic artist to maintain time available for modifying the assignment should the assignment be rejected when no time is necessary.

More commonly, however, the assignment is rejected and the content author must identify changes that need to be made to the authoring assignment. The changes may be made directly on the assignment which causes the original assignment to be altered from its original state. The assignment may then be returned to the graphic artist using one of the mechanisms described above which may further delay completion of the assignment.

These and other drawbacks exist.

### SUMMARY OF THE INVENTION

The foregoing disadvantages are overcome, to a great extent, by the invention, wherein in one aspect a system and method are provided that facilitate processing an authoring assignment. The invention enables an authoring assignment to be requested, forwarded, created, modified, accepted, rejected, and published electronically. The invention enables a user to request that an authoring assignment be created. The request may be created and communicated electronically using an authoring assignment processing system. The request may be received by one or more users that may process the assignment. The assignment may be forwarded for approval to the user that requested the assignment. The requestor may approve or reject the assignment. If the assignment is rejected, the requestor may indicate changes that need to be made to the assignment. The assignment may then be forwarded to the user that created the assignment for further processing.

Upon receiving a rejected assignment, the user may modify the assignment to conform to parameters established by the requestor. After completing the assignment, the assignment may forwarded to the requestor. If desired, the assignment may be approved by the requester or other user. A notification may be transmitted, for example, via electronic mail, text message, phone call, facsimile, etc. to the user that created the assignment notifying the user that the assignment has been approved. The assignment may be forwarded to another user, published, or have another function performed thereon.

According to one embodiment of the invention, the invention may maintain a history of actions performed on the assignment and data relating to each of the actions. For example, the invention may maintain a list of actions performed on the assignment, identifications of users that performed the actions, dates and times relating to the actions, durations of actions, etc.

According to one embodiment of the invention, notes and other documents may be attached to the authoring assignment. Notes may include statements, graphics or other information that a user associated with the authoring assignment may attach to the assignment. Documents may include supporting documents providing information relating to the authoring assignment, source files or other documents.

According to one embodiment of the invention, the request and assignment may be stored as proxy documents. This enables the assignment to be created using proxies in lieu of the actual documents. In this manner, the original documents remain unaltered. The proxy documents may be converted to a final document upon acceptance of the assignment. The proxy documents contain metadata of the final document that enable the proxy document to act as the final document until the final document is created.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIGS. 1A-1D illustrate of a method of processing an authoring assignment according to one embodiment of the invention.

FIG. 2 is an illustration of a system of processing an authoring assignment according to one embodiment of the invention.

FIG. 3 is an illustration of a method of managing user roles in an automated workflow process according to one embodiment of the invention.

FIG. 4 is an illustration of a system of managing user roles in an automated workflow process according to one embodiment of the invention.

FIG. 5 is an illustration of a method of modifying illustrations using scaleable vector graphics according to one embodiment of the invention.

FIG. 6 is an illustration of a system of modifying illustrations using scaleable vector graphics according to one embodiment of the invention.

FIG. 7 is an illustration of an authoring assignment processing display screen according to one embodiment of the invention.

FIG. 8 is an illustration of a rendition and source upload display screen according to one embodiment of the invention.

FIG. 9 is an illustration of an editor display screen according to one embodiment of the invention.

FIG. 10 is an illustration of a systems menu display screen according to one embodiment of the invention.

FIG. 11 is an illustration of a sketch menu display screen according to one embodiment of the invention.

FIG. 12 is an illustration of a symbols menu display screen according to one embodiment of the invention.

FIG. 13 is an illustration of a user inbox according to one embodiment of the invention.

### DETAILED DESCRIPTION OF THE INVENTION

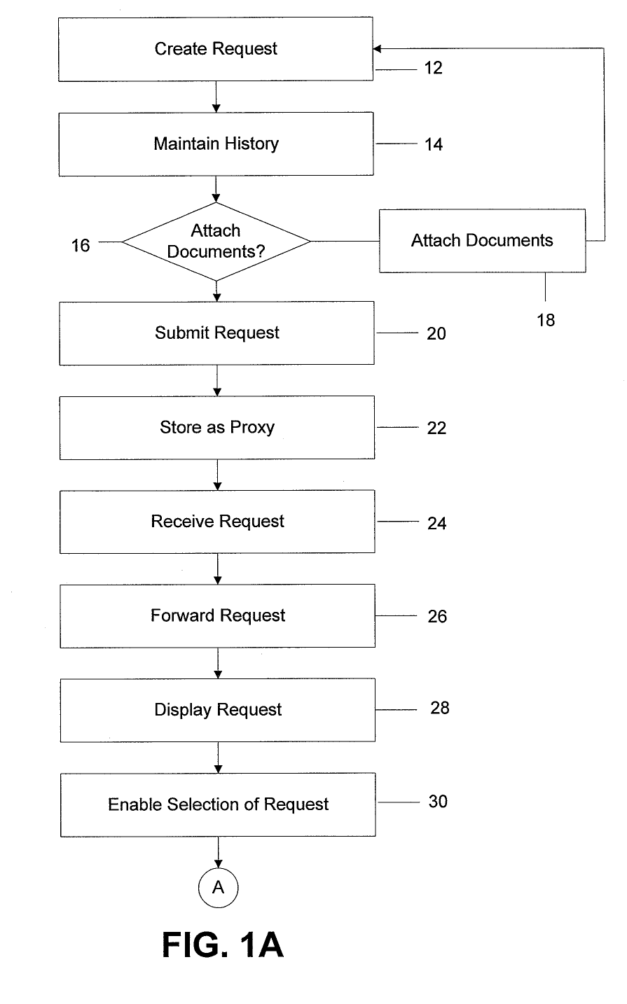

FIG. 1 illustrates a method 10 of processing an authoring assignment according to one embodiment of the invention. According to the method 10, an authoring assignment may be created, processed, forwarded, received, accepted, rejected, and completed. The method 10 may begin by a content author creating a request for an authoring assignment, step 12. Upon creating a request for an authoring assignment, a history of the authoring assignment may be maintained, step 14. The history may maintain a list of all actions performed on the authoring assignment, the identifications of users performing the actions on the authoring assignment, data relating to when the actions were performed such as, for example, date, time, duration, a number of cycles of actions that have been performed on the authoring assignment, and a list of documents that have been attached to the authoring assignment. During the creation of the request, a determination may be made regarding whether one or more documents have been requested to be attached to the request, step 16. If a determination is made that one or more documents have been requested to be attached to the authoring assignment, the documents are attached using any known manner, step 18.

The method 10 may continue with the creation of the request in step 12. During the creation of the request in step 12, the content author may assign one or more parameters to the authoring assignment. The parameters may include, for example, a particular user that must complete the authoring assignment, a due date for the authoring assignment, a base image for the authoring assignment, a format for the authoring assignment or any other desired parameter.

If a determination is made that no document is to be attached to the request, the request may be submitted, step 20. Upon submission of the request, the method 10 may store the request as a proxy, step 22, and not as a graphic of the authoring assignment itself. This enables modifications to be made to the proxy and not to the graphic directly, thus maintaining the request in its original state. According to one embodiment of the invention, the proxies may contain metadata of a final document that enable the proxy document to act as the final document until the final document is created. The proxies are used to re-create the graphic instead of storing the proxy as a graphic. This preserves storage space and enables re-creation of the proxy whereas if, for example, a graphic file becomes corrupted, the graphic may not be easily re-created.

The request may be received by a system that processes the authoring assignment, step 24. The request may be the forwarded, step 26, to one or more user inboxes. If the content author assigned the authoring assignment to a particular user, the authoring assignment is forwarded to the inbox of that user. If the content author did not specify a particular user, the authoring assignment may be forwarded to a general inbox that may be accessed by a plurality of users, to a general inbox of one or more users of the system or other location.

Upon receiving the request, the request is displayed in one or more user inboxes, step 28. According to one embodiment of the invention, the request may be presented in a different format to indicate whether the authoring assignment is a new assignment, a continuing assignment or other assignment. For example, a continuing assignment may be highlighted to indicate that the assignment is an assignment that the user had previously created or modified. Other formatting may also be used.

The method 10 may enable selection of the request by the user, step 30, to enable the user to access the request. The selection may be received, step 32, and then accessed, step 34. A determination is made to determine a version of the request to present, step 36. A request may include multiple versions, therefore, a determination may be made to present the most recent version of the request. If only one version is available, that version is presented. The version of the request that is determined to be the version to present is presented, step 38. The user may then process the request, step 40. Processing of the request may include, for example, modifying a supplied graphic, creating a new graphic or other function. The processing of the request may be performed using any known graphic editor such as, for example, Illustrator™, CorelDraw™, Autocad™ or other system.

A determination is made regarding whether the user has requested to view one or more documents that may have been attached to the request, step 42. If a determination is made that the user has requested to view one or more attached documents, the documents are presented, step 44, and the user may continue processing the request. The method 10, may also determine whether the user has requested to attach one or more documents to the request, step 46. If a determination is made that the user has requested to attach one or more documents to the request, the documents are attached, step 48. Documents that may be attached by the user, may include, for example, notes provided by the user, support documents, related images or other documents. The method 10 may then return to step 40.

A determination may be made in step 50 regarding whether the assignment has been completed. If a determination is made that the assignment is not complete, the method 10, continues with step 40. If a determination is made that the assignment is complete, the user may submit the assignment, step 52. The assignment is received by the system, step 52, and forwarded to the content author that requested the assignment or another user, step 54. The assignment may be displayed in the content author's inbox, step 56. Selection of the assignment by the content author may then be enabled, step 58. The selection is received, step 60, and the assignment is accessed, step 64.

A determination is made to determine which version of the assignment to present, step 66. As discussed above, an assignment or request may include multiple versions. If an assignment includes multiple versions, a most recent version may be determined to be the version to present. The assignment is then presented to the content author, step 68. According to one embodiment of the invention, the assignment may be presented in a side-by-side manner that includes a most recent version on one side and the second version on the other side.

A determination is made regarding whether the content author has accepted the assignment, step 70. If the content author has not accepted the assignment, the content author may process the assignment, step 72. This may include modifying the assignment to reflect desired changes. The content author may reject the assignment, step 74, in which case a second request for the authoring assignment is created and the method 10 returns to step 12.

If a determination is made that the content author has accepted the assignment, the assignment is accepted, step 76. The proxy documents in which the request(s) and assignment have been stored are converted to a final format. The final format may be any desirable format such as, for example, a format identified by the content author or other format. The acceptance is processed, step 80, which may include, for example, notifying the user that created the assignment that the assignment has been accepted, forwarding the assignment to another user, or other function. The final form of the assignment which may be, for example, a graphic, is stored, step 82.

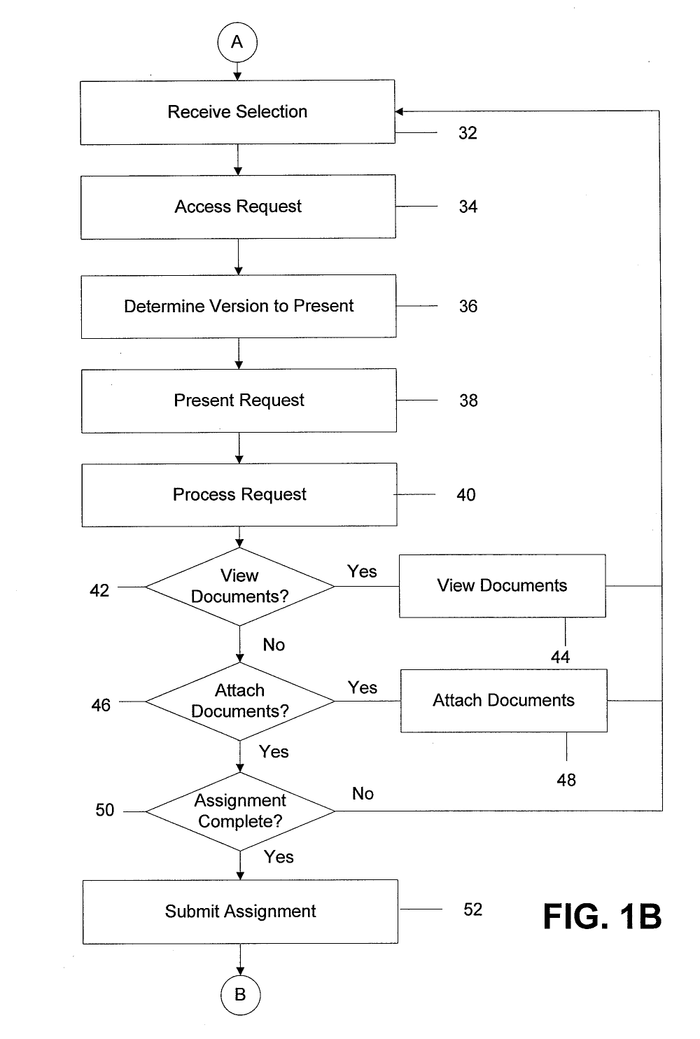

FIG. 2 illustrates a system 100 of processing an authoring assignment according to one embodiment of the invention. The system 100 may include a Request Creating Module 102. The Request Creating Module 102 enables a user to create a request for an authoring assignment. A History Maintaining Module 104 may be used to maintain a history of actions and other data related to the authoring assignment. The history may include, for example, when actions were performed on the authoring assignment, the actions performed on the authoring assignment, identifications of users who have performed actions on the assignment, a date and/or time when the action was performed on the authoring assignment, or other information. The History Maintaining Module 104 may also be used to generate reports relating to the authoring assignment. For example, the report may list actions performed on the authoring assignments, users that have performed actions on the assignment, list of dates when actions were performed, other reports or any combination thereof. The reports may be communicated via, for example, electronic mail, facsimile or other mechanism.

A Document Attaching Determining Module 106 may be used to determine whether a document is to be attached to the authoring assignment. The document may be attached using any known system or method. If the Document Attaching Determining Module 106 determines that one or more documents are to be attached to the authoring assignment, a Document Attaching Module 108 attaches the documents to the authoring assignment.

A Request Submitting Module 110 may be used to submit the request to create an authoring assignment. A Proxy Storing Module 112 may be used to store the requests and the authoring assignment as proxy documents. This enables proxies of the request and authoring assignment to be modified instead of the actual request and/or the authoring assignment. The request may be received by a Request Receiving Module 114. The request may be forwarded to a particular user, a general inbox that may be accessible to multiple users, a general inbox associated with one or more users of an authoring assignment processing system or other location. A Request Displaying Module 118 may be used to display the requests to the users in, for example, an inbox or other mechanism. A Request Selection Enabling Module 120 may be used to enable the user to select the request for accessing. A Selection Accessing Module 122 may be used to access the selection received from the user. A Request Accessing Module 124 may be used to access the request selected by the user.

A Version Determining Module 126 may be used to determine a version to present to the user based on the selection received. The request may be presented to the user using a Request Presenting Module 128. The request may be processed by the user using a Request Processing Module 130. A Document Viewing Determining Module 132 may be used to determine whether the user has requested to view one or more documents attached to the request. If a determination is made that the user has requested to view one or more documents, a Document Presenting Module 134 may be used to present the documents to the user. An Assignment Completion Determining Module 136 may be used to determine whether the assignment is completed. If a determination is made that the assignment is complete, the assignment may be submitted using Assignment Submitting Module 138. The assignment may be received using Assignment Receiving Module 140.

The assignment may be forwarded to one or more users using an Assignment Forwarding Module 142. The assignment may be forwarded to, for example, a particular user identified by the content author of the request, a general inbox that is accessible to a plurality of users, a general inbox of one or more users of the system or other user. The assignment may be displayed to the user or users using an Assignment Displaying Module 144. An Assignment Selection Enabling Module 146 enables the user to select an assignment presented in an inbox or other mechanism. An Assignment Accessing Module 148 enables the user to access the assignment selected. An Assignment Presenting Module 150 presents the assignment to the user.

An Acceptance Determining Module 152 determines whether the user has accepted the assignment. If a determination is made that the user has not accepted the assignment, the user may process the assignment using an Assignment Processing Module 154. The assignment may then be rejected using an Assignment Rejecting Module 156. The assignment may be returned to the user that created the assignment. If the Acceptance Determining Module 152 determines that the assignment has been accepted, the assignment may be accepted using Assignment Accepting Module 158. Proxy documents of the request and assignment may be converted to a graphic or final form of the assignment using Proxy Converting Module 160. The proxy documents may be converted to any desired format, such as, for example, TIFF, JPEG, Bitmap or other desired format. An Acceptance Processing Module 162 processes the acceptance. Acceptance processing may include, for example, forwarding a notification to the assignment creator that the assignment has been accepted, forwarding the assignment to another user or other function. A final graphic of the assignment may be stored using a Graphic Storing Module 164.

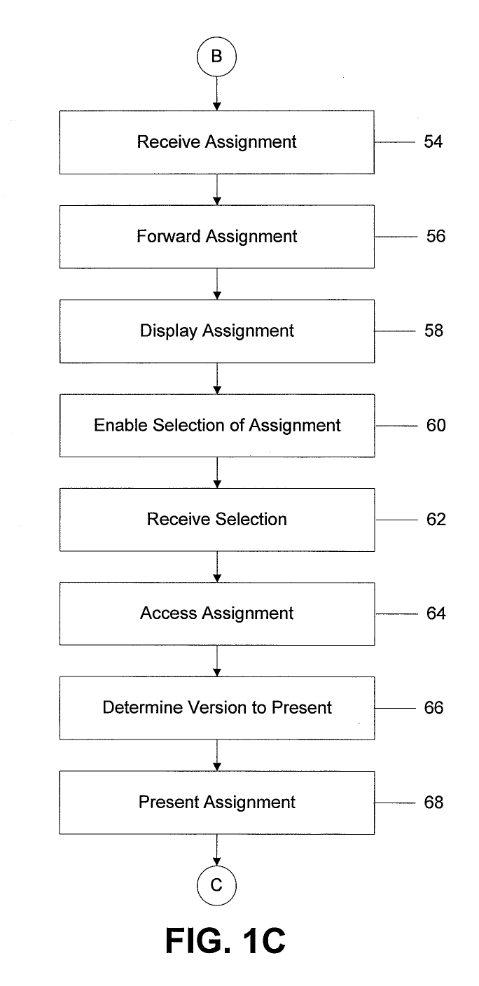

FIG. 3 illustrates a method 200 of managing user roles relating to an authoring assignment, according one embodiment of the invention. A criteria for one or more user roles may be established in step 202. The criteria may include, for example, functions that users assigned to a particular role may perform, other users in that role that may accept or reject assignments or other criteria. The method 200 may also enable customization of the criteria, step 204. This enables system administrators or other users to customize criteria associated with user roles of an authoring assignment system. One or more roles may be assigned to one or more users of the system, step 206. Roles may include, for example, graphic artist, manager, coordinator, content author, illustrator, publisher or other desired role. The roles may also be modified in step 208. For example, a graphic artist role may be modified to include a coordinator role and illustrator role. Additionally, functions that a particular role may perform may be changed. The method 200 may also enable a user to perform functions associated with an authoring assignment. For example, the user may be enabled to create, modify, approve, reject, publish or other function relating to an authoring assignment. The method 200 may also maintain a history, step 212, of actions performed on an authoring assignment. For example, a history may include actions performed on the authoring assignment, identification of users who performed the actions on the authoring assignment, dates and times when the actions were performed on the authoring assignment.

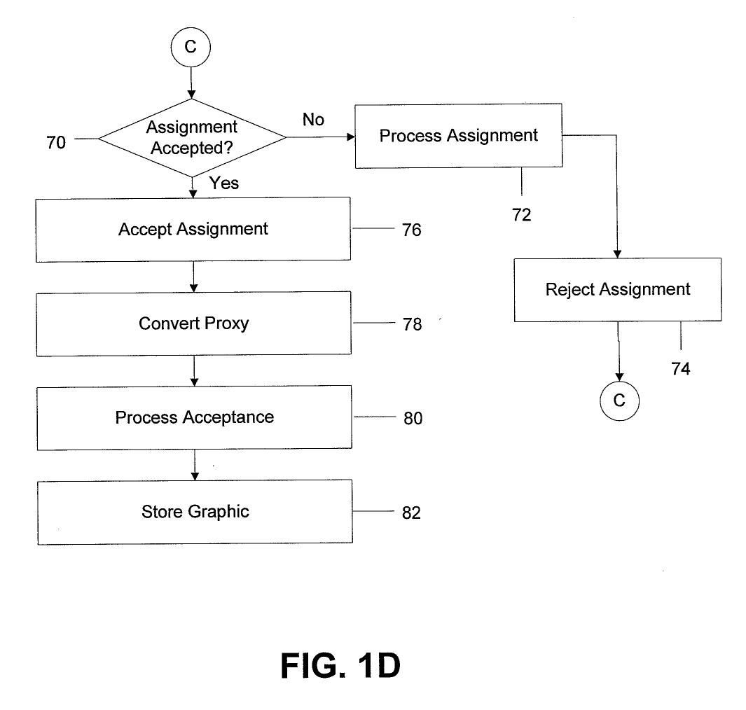

FIG. 4 illustrates a system 250 of managing user roles relating to authoring assignment according to one embodiment of the invention. The system 250 may include a Criteria Establishing Module 252 that enables criteria for one or more user roles to be established. A Criteria Customizing Module 254 may be used to customize the criteria established by the Criteria Establishing Module 252. A Role Assigning Module 256 may assign one or more roles to one or more users of a system that processes authoring assignments. The roles of users may be modified using Role Modifying Module 258. This enables users to add, remove, or otherwise modify roles assigned to a user. A Function Performing Enabling Module 260 may be used to enable the users to perform functions on authoring assignments. A History Maintaining Module 262 may be used to maintain a history relating to actions performed on an authoring assignment as described above.

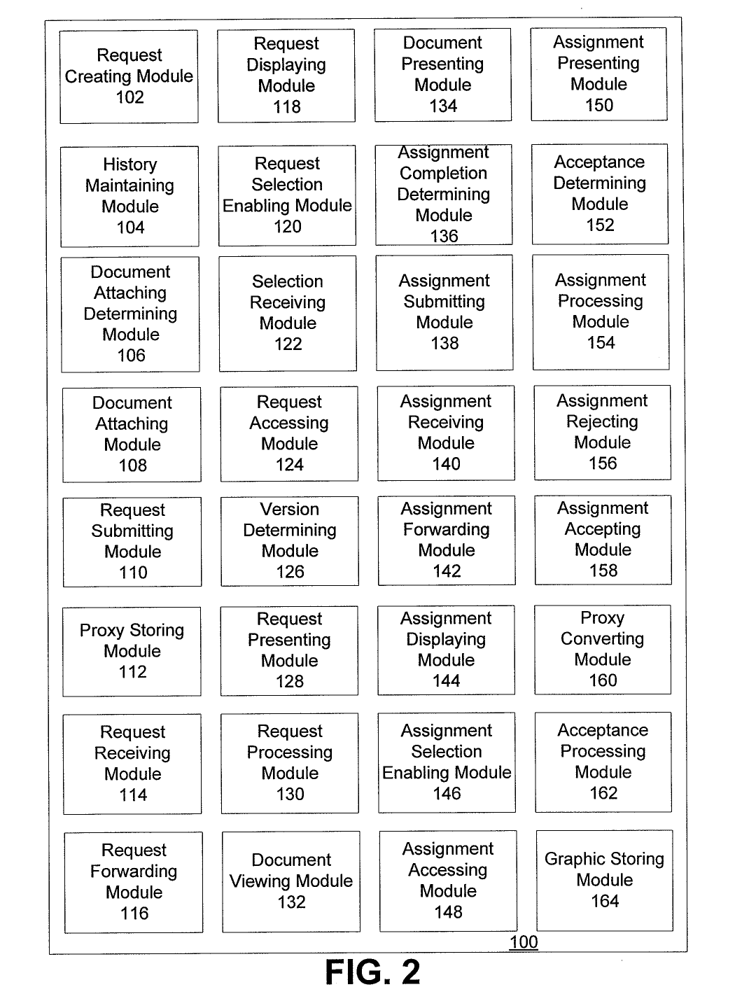

FIG. 5 illustrates a method 300 of modifying an authoring assignment using scalable vector graphics, according to one embodiment of the invention. The method 300 may include an access illustration step 302 that enables a user to access an illustration. Upon accessing an illustration, a scalable vector graphics layer may be super-imposed on the illustration, step 304. Positional coordinates of the scalable vector graphics layer may be determined in step 306.

The method 300 enables markings to be applied to the scalable vector graphics layer, step 308, to provide a rendition of an illustration having those markings without providing markings on the actual illustration. A user may provide markings on the scalable vector graphics layer using any desired input mechanism such as, for example, a light pen, touch screen, keyboard, computer mouse, stylus or other input mechanism. The markings may be presented to the user in step 310.

The method 300 may also enable the user to modify the markings, step 312. This may include, for example, moving, deleting, altering, or otherwise modifying the markings. A plurality of pre-defined symbols may also be provided, step 314. The symbols may be, for example, symbols customarily used with modifying illustrations such as, for example, arrows, lead lines, call-outs, etc. The method 300 may also enable the symbols to be selected and positioned on the scalable vector graphics layer, step 316. The symbols may be selected and positioned using any desired input mechanism such as those described above. The method 300 may then create a composite of the illustration and the scalable vector graphics layer, step 318. The composite provides a rendition of the illustration having those markings without the illustration actually having those markings. Alternatively, a line drawing may be created, step 320, using the illustration and the scalable vector graphics layer.

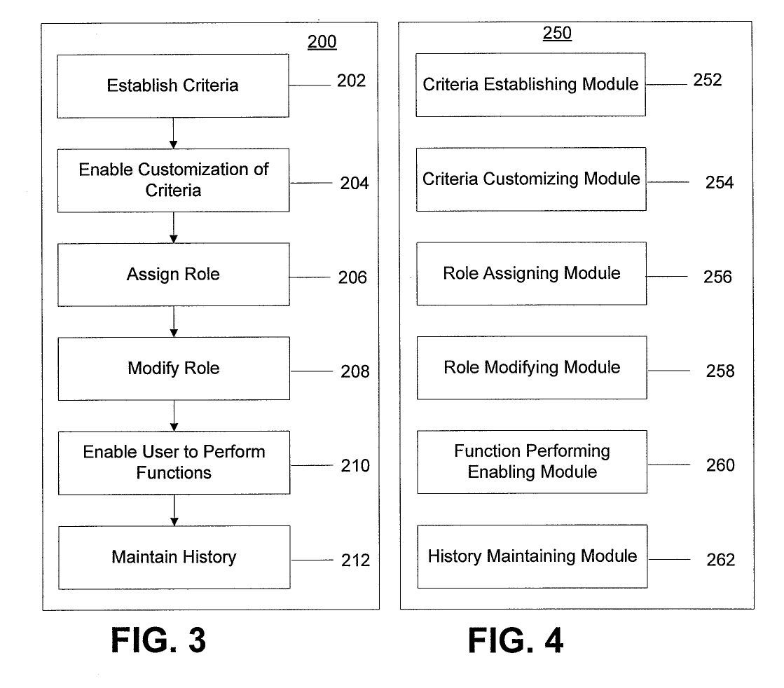

FIG. 6 illustrates a system 350 of modifying an authoring assignment using scalable vector graphics according to one embodiment of the invention. The system 350 may include an Illustration Accessing Module 352 that enables a user to access an illustration. A Scalable Vector Graphics Layer Super-imposing Module 354 may be used to super-impose a scalable vector graphics layer on the illustration. The scalable vector graphics layer receives markings or other modifications desired to be applied to the illustration. A Positional Coordinates Determining Module 356 may be used to determine positional coordinates of the scalable vector graphics layer. This enables a determination to be made regarding where the markings should be applied on the illustration.

A Markings Applying Enabling Module 358 may be used to enable markings to be applied to the scalable vector graphics layer without providing the markings on the actual illustration. A Markings Presenting Module 360 may be used to present the markings on the scalable vector graphics layer. A Markings Modifying Enabling Module 362 may be used to enable the user to modify the markings on the scalable vector graphics layer. The may include, for example, deleting, moving, altering, or otherwise modifying a marking applied to the scalable vector graphics layer.

A Symbol Providing Module 364 may be used to provide a user with pre-defined symbols that may be applied to the scalable vector graphics layer. The symbols may include, for example, simple arrows, diagonal arrows, call-outs, lead lines or other symbols desired to be associated with an authoring assignment processing tool. A Symbol Selecting and Positioning Enabling Module 366 may be used to enable a user to select and position one or more symbols on a scalable vector graphics layer. The user may select and position the symbols using, for example, a conventional computer mouse, keyboard, light pen, touch-screen, stylus or other input mechanism that enables the user to select the symbol and move the symbol to a desired location on the scalable vector graphics layer. A Composite Creating Module 368 may be used to create a composite graphic of the illustration and the scalable vector graphics layer having the markings such that a user may view a graphic of the illustration with the markings as desired and as shown on the scalable vector graphics layer. A Line Drawing Creating module 370 may be used to create a line drawing of the illustration with the markings provided on the scalable vector graphics layer.

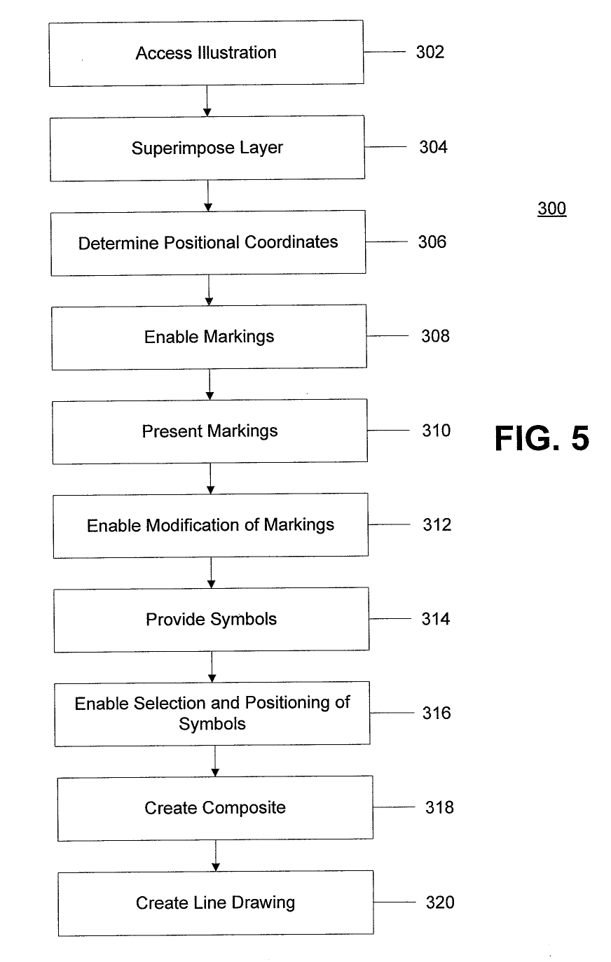

FIG. 7 illustrates an Authoring Assignment Processing Display Screen 400 according to one embodiment of the invention. The Display Screen 400 may include a Title Section 402, a Graphic Section 404, a Supporting Document Section 406, a History Section 408, a Control Area 410, a Notes Section 412, a Source/Rendition Section 414, and a Folder Section 416.

The Graphic Section 404 may include a Graphic Header 418 that identifies the Graphic Section 404. The Graphic Section 404 may include a Graphic Display Area 420 that displays a graphic associated with the authoring assignment. Store and Edit Selectors 422 and 424, respectively, may also be included in the Graphic Section 404. This enables a user to store the graphic to a desired location by selecting Store Selector 422 or edit the graphic by selecting the Edit Selector 424. The Store and Edit Selectors 422 and 424 may be selected using any known input mechanism as described above.

The Supporting Document Section 406 may include a Supporting Document Header 426 that identifies the Supporting Document Section 406. An Add Document Selector 428 may be provided to enable the user to attach a supporting document to the authoring assignment. The Supporting Document Section 406 may also include Document Details Areas 430a-430n that provide details regarding documents that have been attached to the authoring assignment and associated with the graphic displayed in the Graphics Section 404.

The History Section 408 may include a History Header 432 that identifies the History Section 408. A History Area 434 may be provided that includes a list of actions that have been performed on the authoring assignment, identifications of users that have performed each of the actions, dates and times of when the actions were performed, and other information. The History Section 408 may also include Vertical and Horizontal Scroll Bars 436 and 438, respectively, that enable the user to scroll through the History Area 434.

The Control Section 410 may include a Control Header 440 that identifies the Control Section 410. The Control Section 410 may also include a Control Area 442 that provides various functions and options that may be performed on the authoring assignment. The Control Area 442 may include the following selectors: Send For Creation 444; Side-by-Side Preview Area 446; Prepare Rejection 448; Side-by-Side 450; and Save and Close 452. The Send For Creation Selector 444 enables a user to send an authoring assignment that has been created to, for example, a content author that requested the assignment. The Side-by-Side Preview Area 446 may display a most recent version of the authoring assignment alongside a second most previous version of the assignment in a particular area within the Control Section 410. This enables the user to view two or more previous versions to compare changes between or among the versions. The Prepare Rejection Selector 448 enables the user to prepare a rejection of the authoring assignment. The Side-by-Side Selector 450 enables the user to present a side-by-side display in a larger area, for example, in a separate area. The Save and Close Selector 452 enables the user to save the authoring assignment to a desired location and close the authoring assignment.

The Notes Section 412 may include a Notes Header 454 that identifies the Notes Section 412. The Notes Section 412 may also include a Notes Area 456 that includes an add Note Selector 458 and one or more Note Details Areas 460a-460n. The Add Note Selector 458 enables the user to attach a note to the authoring assignment. The note may provide text or other information regarding the authoring assignment. The Note Details Areas 460a-460n display notes that have been attached to the authoring assignment.

The Source/Rendition Section 414 may include a Source/Rendition Header 462 that identifies the Source/Rendition Section 414. The Source/Rendition Section 414 may include an Upload Selector 464, a Source Details Area 466, and a Rendition Details Area 468. The Upload Selector 464 enables a user to upload a source file or rendition of the assignment to be attached to the authoring assignment. The Source Details Area 466 provides details regarding a source file attached to the authoring assignment. The Rendition Details Area 468 provides details regarding a rendition of the authoring assignment.

The folder section 416 may include a folder area 470 that includes one or more folders 472a-472n. Each of the folders 472a-472n may represent a different version of an authoring assignment. For example, as an authoring assignment is processed, multiple versions of the assignment may be created. Upon creation of each version, a new folder 472 may be created to store the assignment in its current state. This may include storing a version of the assignment as created or modified, supporting documents that have been currently attached, current notes, and other information.

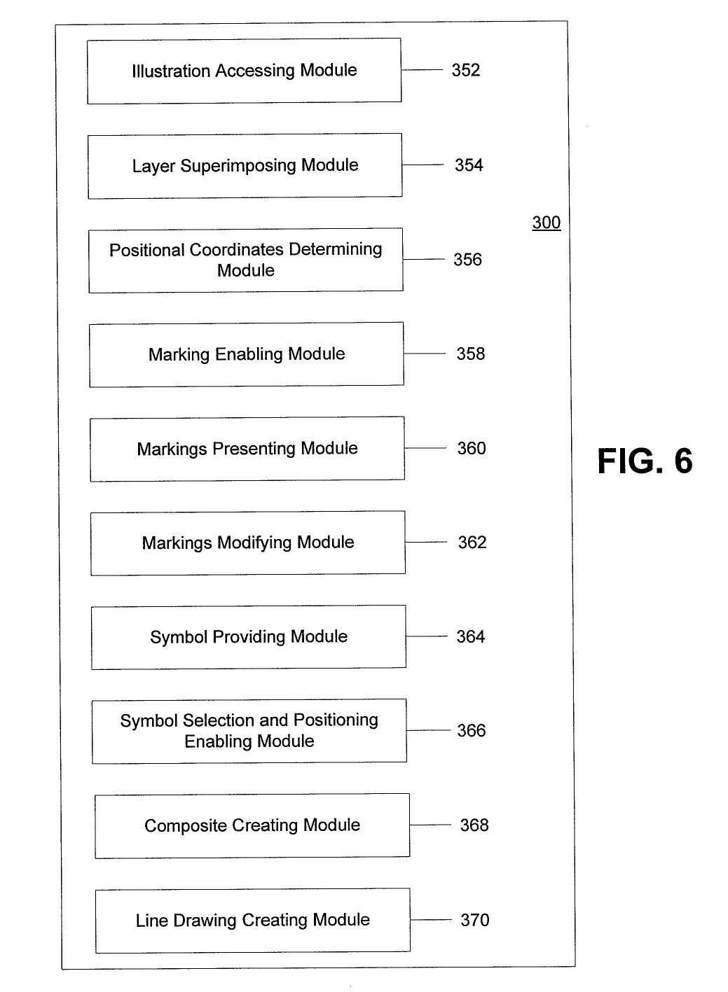

FIG. 8 illustrates a Rendition and Source Upload Display Screen 500 according to one embodiment of the invention. The Rendition and Source Upload Display Screen 500 may include an Upload Title Area 502 that provides a title for the Rendition and Source Upload Display Screen 500. A Format Identifier 504 may be provided that identifies a format of a rendition that has been or may be uploaded. A Rendition Title Area 506 may provide a title for the rendition to be uploaded. One or more Rendition Data Areas 508a-508n may provide data regarding the rendition to be uploaded. For example, the data may include a file name of the rendition, a location of the rendition or other information. A Browse Selector 510 may be provided to enable the user to browse one or more locations for a desired rendition to be uploaded.

A Format Identifier 512 may be provided to identify a format of a source file to be uploaded to an authoring assignment. A Source Title Area 514 may be used to provide a title for the source to be uploaded. One or more Source Data Areas 516a-516n may be used to provide data regarding a source file to be uploaded and attached to an authoring assignment. As discussed above, the data may include a title of a source file, a location of a source file or other information. A Browse Selector 518 may be provided to enable a user to search one or more locations for a desired source file to be uploaded. The Rendition and Source Upload Display Screen 500 may also include Upload Selector 520 and Cancel Selector 522. The Upload Selector 520 may enable the user to upload the source and/or rendition files selected and the Cancel Selector 522 may enable the user to cancel the uploading of a source and/or a rendition file to an authoring assignment.

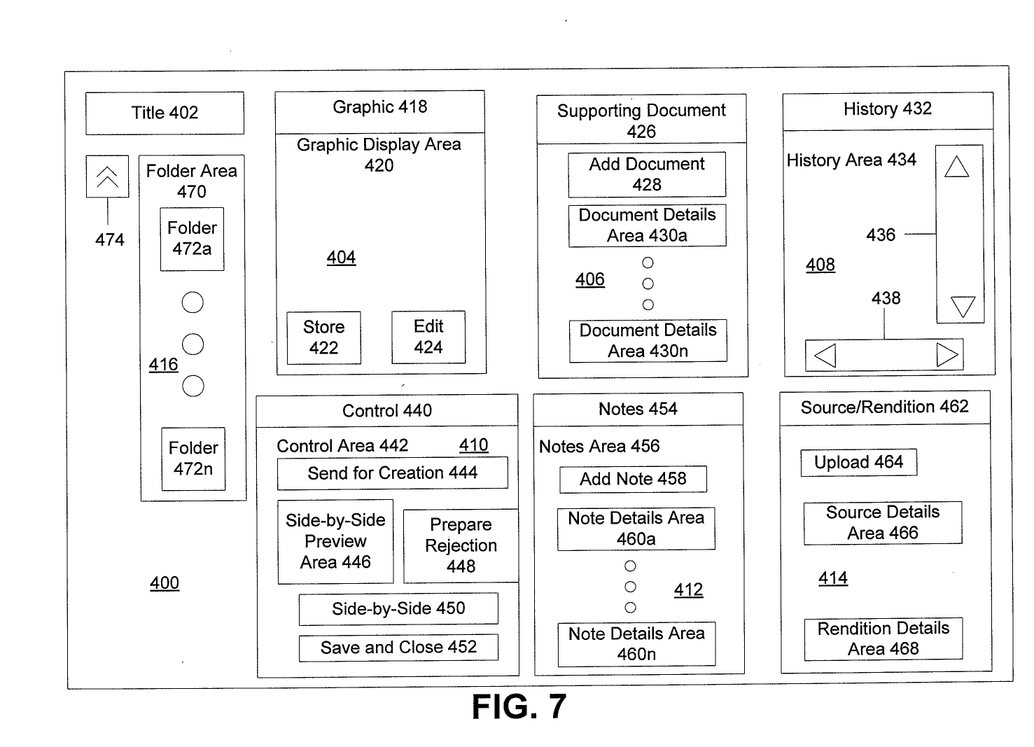

FIG. 9 illustrates an Editor Display Screen 550 according to one embodiment of the invention. The Editor Display Screen 550 may include an Editing Area 554 and an Editor Menu 556. The Editor Menu 556 may include one or more Selectors 558a-558n that enable a user to select a function to perform. The Selectors 558a-558n may include, for example, a Systems Menu Selector 558a, a Call-Outs Selector 558b, a Symbols Selector 558c, a Sketch Selector 558d, an About Selector 558e or Other Selectors 558n. The Systems Menu Selector 558a may provide a menu of operations that may be performed on an authoring assignments such as, for example, save and cancel operations. The Call-Outs Selector 558b may provide a list of pre-defined call outs that may be used when creating or modifying an authoring assignment. The Symbols Selector 558c may provide a list of pre-defined symbols that a user may use when creating or modifying an authoring assignment. The Sketch Selector 558d may enable the user to provide markings on an authoring assignment using an input mechanism such as, for example, a light pen, stylus, touch screen, keyboard, computer mouse or other input mechanism. The About Selector 558e may provide information regarding the editor such as, for example, a copyright date, owner, description of the editor, and other information. Other selectors may also be provided.

The Editing Area 554 may include a Graphic Areas 560. The Graphics Area 560 may present a graphic of an authoring assignment that is to be created or modified. A user may modify a graphic within the Graphics Area 560 using, for example, the Selectors 558a-558n.

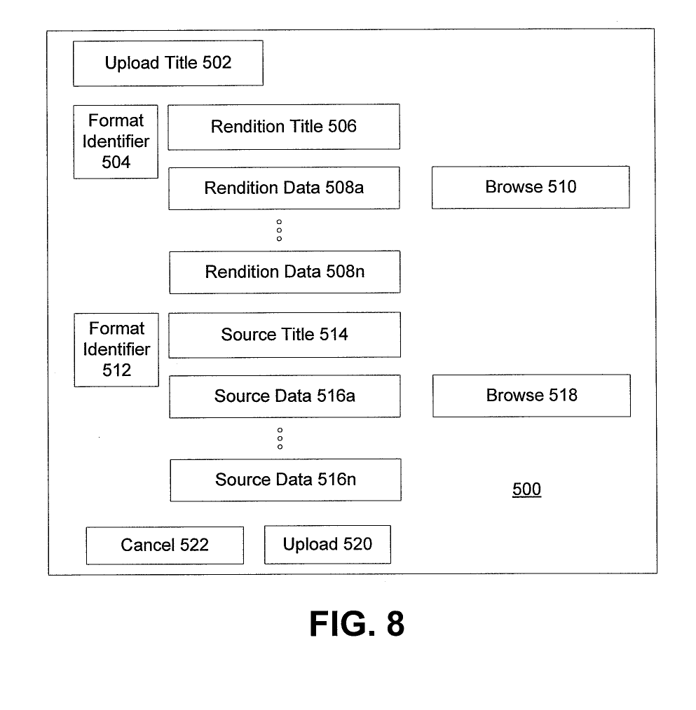

FIG. 10 illustrates a Systems Menu 600 that may be presented upon selection of the Systems Menu Selector 558a shown in FIG. 9. The System Menu 600 may include a System Menu Header 602 that identifies the System Menu 600. The Systems Menu 602 may include a Save and Close Selector 604 that enables the user to save and close an assignment displayed in the editor. A Description Area 606 may be provided to present a description of operations performed upon selecting the Save and Close Selector 604. The Systems Menu 602 may also include a Cancel Selector 608 that enables the user to cancel a creation or modification of an authoring assignment. A Description Area 610 may provide a description of functions performed upon selecting the Cancel Selector 608.

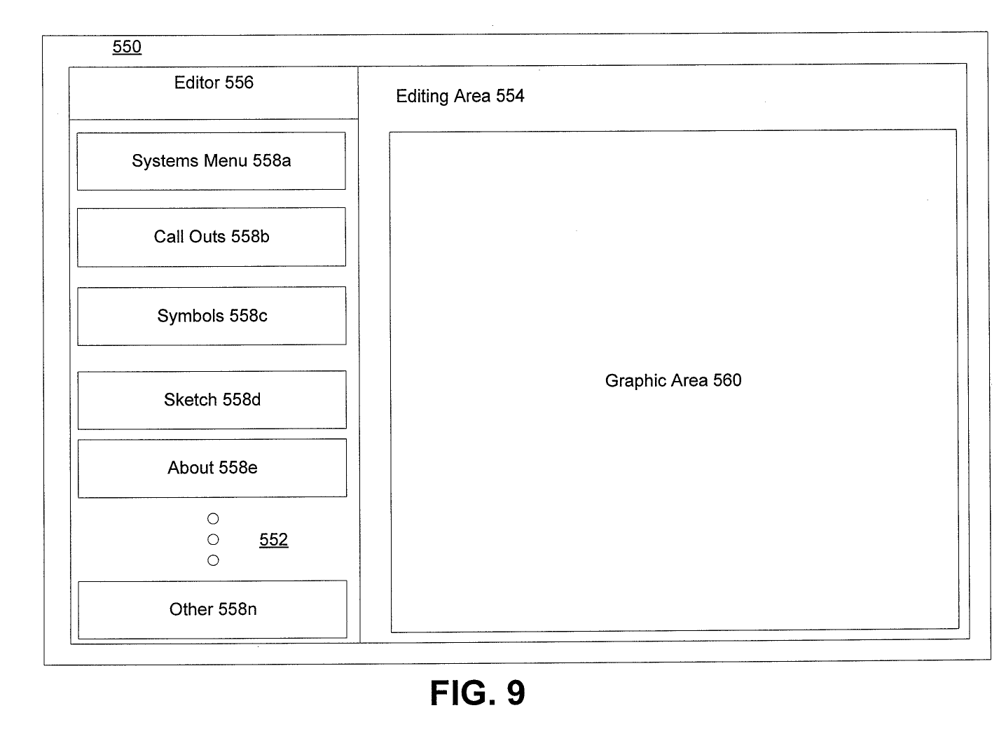

FIG. 11 illustrates a Sketch Menu Display Screen 620 according to one embodiment of the invention. The Sketch Menu Display Screen 620 may include a Sketch Title Area 622 that identifies the Sketch Menu Display Screen 620. The Sketch Menu Display Screen 620 may include a Start Edit Selector 624 and a Stop Edit Selector 626. The Start Edit Selector 624 may enable the user to begin editing an authoring assignment. The Stop Edit 626 may enable the user to cease editing an authoring assignment. Upon selection of either the Start Edit Selector 624 or the Stop Edit Selector 626, a history of these actions may be stored by the system.

The Sketch Menu Display Screen 620 may also include a Pen Selector 628 and Highlighter Selector 630. The Pen Selector 628 may enable a user to modify a graphic of the authoring assignment as if using a pen to provide markings on the graphic. The Highlight Selector 630 may enable the user to provide highlighting on one or more portions of the graphic. One or more parameter Selectors 632a-632n may be provided to specify a parameter of use with the Pen Selector 628 and the Highlighter Selector 630. For example, the selectors may include a Yellow Selector 632a, Red Selector 632b, Blue Selector 632c, Green Selector 632d, Black Selector 632e, White Selector 632f or Other Selectors 632n. The Selectors 632a-632n may specify a particular color, shape, width or other parameter to be applied to a pen or highlighting function performed on the graphic. Each of the Selectors 628, 630, and 632a-632n may be selected using radio buttons provided adjacent each selector. The Sketch Menu Display Screen 620 may also include an Available Sketches Selector 636 that enables a user to request sketches that are available and associated with the authoring assignment. An Identifier Selector 638 may also be provided to enable identification of users that created the sketches available.

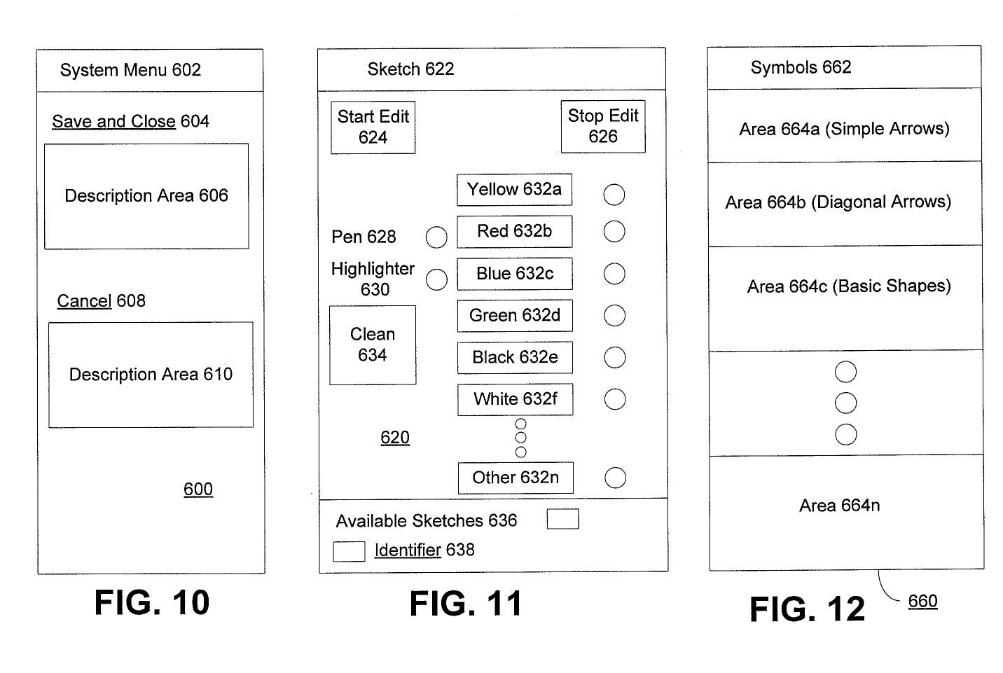

FIG. 12 illustrates a symbols menu display screen 660 according to one embodiment of the invention. The symbols menu display screen 660 may include a symbols title area 662 that identifies the symbols menu display screen 660. The symbols menu display screen 660 may include one or more areas 664a-664n that provide pre-defined symbols that a user may use when creating or modifying an authoring request. For example, area 664a may provide a list of simple arrows, area 664b may provide a list of diagonal arrows, and area 664c may provide a list of basic shapes that are typically used when creating an authoring assignment. Other symbols may also be provided in area 664n.

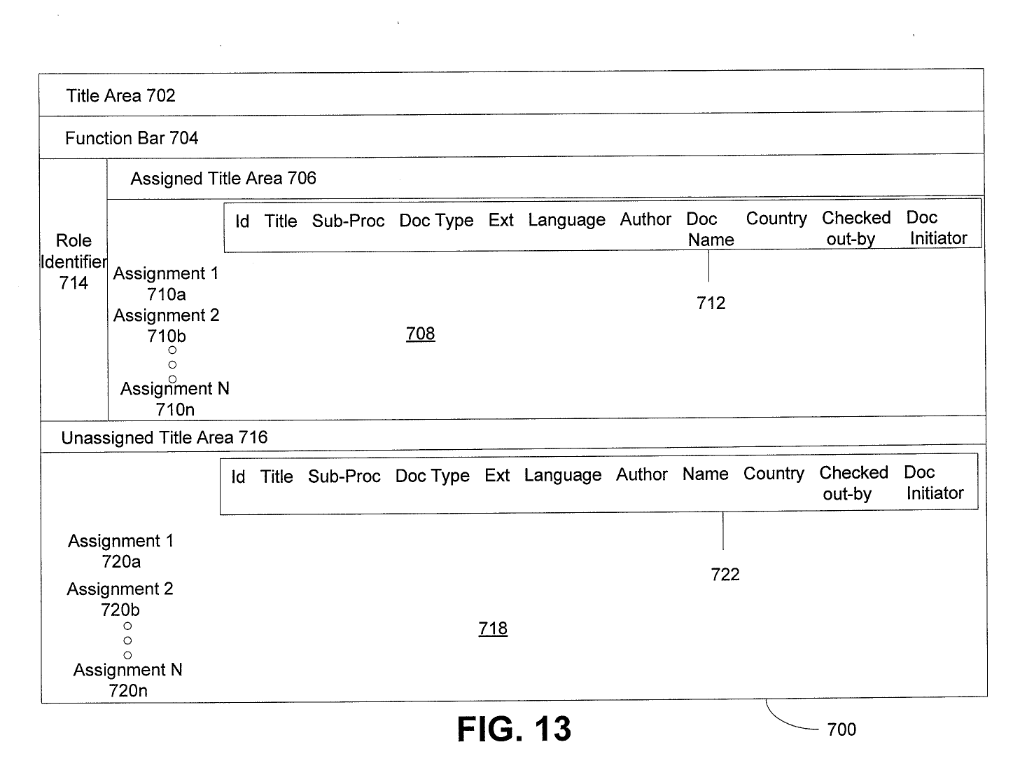

FIG. 13 illustrates a user inbox 700 according to one embodiment of the invention. The user inbox 700 may include a title area 702 that provides a title such as, for example, “My Workbasket,” of the inbox 700. A function bar 704 may be provided that provides standard function selectors. For example, Back, Refresh, Search, and other functions may be provided in the function bar 704. The inbox 700 may also include an assigned title area 706 that identifies assignments assigned to the user of the inbox 700. The user inbox 700 may include an assigned assignments display area 710 that provides a list of assignments 712a-712n that have been assigned to that user. An information bar 714 may be provided that provides information regarding each of the assignments listed in the assigned assignments display area 710. The information bar 714 may, for example, provide an identification of an authoring assignment, title, sub-processes, document type, extension, language, author, document name, country, checked-out by, document initiator, or other information relating to the assignment.

The user inbox 700 may also include an unassigned title area 716 that identifies assignments that have not been assigned to a particular user but have been submitted to a general inbox. The user inbox 700 may include an unassigned assignments area 718 that lists one or more assignments 720a-720n that have been requested but unassigned to a particular user. The unassigned assignment area 718 may include an information bar 722 such as the information bar 712 discussed above.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of processing an authoring assignment comprising:
enabling a request for an authoring assignment to be created by an initiating user;
receiving the request;
processing the request;
enabling a subsequent user access to the request;
facilitating processing of the authoring assignment by the subsequent user;
receiving a version of the authoring assignment; and
accepting the version of the authoring assignment.

2. The method of claim 1, further comprising maintaining a history of the authoring assignment.

3. The method of claim 1, wherein the history comprises any of actions performed on the authoring assignment, identifications of users performing the actions, data relating to when the actions were performed, a duration of each of the actions, a number of cycles of the actions performed on the authoring assignment, and a list of documents attached to the authoring assignment.

4. The method of claim 1, further comprising enabling any of the initiating user and the subsequent user to perform any of: attaching a note to the authoring assignment, attaching a file to the authoring assignment, viewing a history of the authoring assignment, and viewing a source file of the authoring assignment.

5. The method of claim 1, further comprising storing the authoring assignment as a proxy document until the version of the authoring assignment is accepted.

6. The method of claim 5, further comprising converting the proxy document upon acceptance of the version of the authoring assignment.

7. The method of claim 5, wherein the proxy document comprises metadata of the authoring assignment.

8. The method of claim 1, further comprising enabling the initiating user to reject the version of the authoring assignment.

9. The method of claim 1, further comprising determining the version of the authoring assignment to present.

10. The method of claim 1, further comprising enabling the initiating user to any one of assign the authoring assignment to the subsequent user, assign a due date for the authoring assignment, identify a base image for the authoring assignment, and identify a format for the authoring assignment.

11. The method of claim 1, further comprising enabling any of the initiating user and the subsequent user to select an authoring assignment to access.

12. The method of claim 1, further comprising presenting the version of the authoring assignment to any of the initiating user and the subsequent user.

13. The method of claim 12, further comprising presenting the version of the authoring assignment and a previous version of the authoring assignment in a substantially parallel arrangement.

14. A system of processing an authoring assignment comprising:
a request creating module configured to enable an initiating user to create a request for an authoring assignment;
a request receiving module configured to receive the request;
a processing module configured to process the request;
an accessing module configured to enable a subsequent user access to the request;
a facilitating module configured to facilitate processing of the authoring assignment by the subsequent user;
a version receiving module configured to receive a version of the authoring assignment;
a version accepting module configured to accept the version of the authoring assignment; and
a storing module configured to store the version of the authoring assignment.

15. The system of claim 14, further comprising a maintaining module configured to maintain a history of the authoring assignment.

16. The system of claim 14, wherein the history comprises any of actions performed on the authoring assignment, identifications of users performing the actions, data relating to when the actions were performed, a duration of each of the actions, a number of cycles of the actions performed on the authoring assignment, and a list of documents attached to the authoring assignment.

17. The system of claim 14, further comprising an attaching module configured to enable any one of the initiating user and the subsequent user to any one of attach a note and a file to the authoring assignment.

18. The system of claim 14, wherein the authoring assignment is stored as a proxy document until the version of the authoring assignment is accepted.

19. The system of claim 18, further comprising a converting module configured to convert the proxy document upon acceptance of the version of the authoring assignment.

20. The system of claim 17, wherein the proxy document comprises metadata of the authoring assignment.

21. The system of claim 14, further comprising a rejecting module configured to enable the initiating user to reject the version of the authoring assignment.

22. The system of claim 14, further comprising a determining module configured to determine the version of the authoring assignment to present.

23. The system of claim 14, further comprising an assigning module configured to enable the initiating user to assign any one of the subsequent user, due date, base image, and format for the authoring assignment.

24. The system of claim 14, further comprising a selection receiving module configured to receive a selection of the authoring assignment by any of the initiating user and the subsequent user.

25. The system of claim 14, further comprising a presenting module configured to present the authoring assignment to any of the initiating user and the subsequent user.

26. The system of claim 14, further comprising a storing module that stores the authoring assignment as a proxy document.
